(19) United States
(12) Patent Application Publication
(10) Pub. No.: US 2025/0327156 A1
(43) Pub. Date: Oct. 23, 2025

(54) HIGH-STRENGTH PETROLEUM PIPE CASING AND MANUFACTURING METHOD THEREFOR

(71) Applicant: BAOSHAN IRON & STEEL CO., LTD., Shanghai (CN)

(72) Inventors: Xiaoming DONG, Shanghai (CN); Zhan GAO, Shanghai (CN); Liyang PENG, Shanghai (CN); Fuchang XU, Shanghai (CN)

(73) Assignee: BAOSHAN IRON & STEEL CO., LTD., Shanghai (CN)

(21) Appl. No.: 18/870,424

(22) PCT Filed: May 29, 2023
(86) PCT No.: PCT/CN2023/096906

§ 371 Date: Nov. 28, 2024

(30) Foreign Application Priority Data
May 30, 2022 (CN) 202210597712.0

(51) Int. Cl. C22C 38/14; C21D 8/10; C21D 9/08; C22C 38/00; C22C 38/02; C22C 38/04; C22C 38/06; F16L 9/02

(52) U.S. Cl. CPC C22C 38/14; C21D 8/105; C21D 9/085; C22C 38/001; C22C 38/002; C22C 38/005; C22C 38/02; C22C 38/04; C22C 38/06; F16L 9/02; C21D 2211/003; C21D 2211/005

(57) ABSTRACT

Disclosed is a high-strength petroleum pipe casing, which contains Fe and inevitable impurity elements, and further contains the following chemical elements in percentage by mass: 0.06-0.15% of C, 0.3-0.5% of Si, 1.5-2.2% of Mn, 0.002-0.006% of rare earth (La, Ce), less than or equal to 0.05% of Ti, 0.01-0.03% of Al, and greater than 0 but less than or equal to 0.008% of N. Correspondingly, also disclosed is a manufacturing method for the high-strength petroleum pipe casing. The manufacturing method comprises the steps: (1) smelting and casting; (2) perforation; (3) rolling; (4) sizing; (5) online quenching: controlling the temperature of the pipe casing body before cooling to be not lower than 780° C.; water cooling the outer surface of the pipe casing, the cooling speed being 40-100° C./s, and controlling the final cooling temperature to be not higher than 100° C.; (6) tempering, wherein the tempering temperature is controlled to be 500-620° C., and the heat preservation time is 40-70 min; and (7) hot straightening.

### TECHNICAL FIELD

The present disclosure relates to a steel pipe and a method for manufacturing the same, in particular to a petroleum casing pipe and a method for manufacturing the same.

### BACKGROUND ART

In recent years, seamless steel pipes have been widely used in the fields of oil and gas, energy, etc., and play a very important role. They are known as the “blood vessels of industry”, and are an irreplaceably important category of steel.

In the prior art, seamless pipe steel grades commonly used for oil and gas wells include API standard grades such as N80-Q and P110. The inventors have discovered by research that these casing pipes are all prepared using a process of hot rolling+quenching and tempering heat treatment during production. After hot rolling, they need to be cooled to room temperature and then reheated in a quenching heating furnace for quenching heat treatment. This process not only wastes the residual heat of the steel pipe after rolling (the temperature of the steel pipe after rolling is usually 900° C. or higher), but also involves an extra heat treatment step, leading to increased cost and large consumption of resources and energy, which brings many restrictions to the development and efficient production of high-quality pipes.

Therefore, in order to reduce energy consumption and improve steel strength, existing sheets are often prepared using a process involving controlled rolling and controlled cooling. However, it should be noted that due to its special annular cross-section, the internal stress state of a seamless steel pipe is more complicated than that of a sheet. In the controlled cooling process such as online quenching where waste heat is utilized, it is easy to cause cracking of the steel pipe. In addition, due to the high rolling temperature, the grain size of the steel pipe is large, which is not conducive to improving strength and toughness.

For example, Chinese Patent Application CN103774063A, published on May 7, 2014, and titled “LARGE-CALIBER PETROLEUM CASING PIPE AND TMCP PRODUCTION METHOD FOR SAME”, discloses a low carbon equivalent microalloyed steel pipe and an online normalizing process for the same. The steel pipe has stable mechanical properties and good anti-collapse performance. This technical solution adopts the TMCP production method, which has a simple process and high production efficiency. However, this patent application uses medium-carbon CrMo steel. It's similar to the material of conventional oil well pipes, and there is still a risk of cracking during online quenching.

For another example, Chinese Patent Application CN103757561A, published on Apr. 30, 2014, and titled “LARGE-CALIBER THICK-WALLED SEAMLESS STEEL PIPE FOR MARINE USE AND TMCP PRODUCTION METHOD FOR SAME”, discloses a large-caliber thick-walled seamless steel pipe for marine use and a TMCP production method for the same. The steel pipe has stable mechanical properties and good low-temperature impact performance, but its high alloy content leads to the risk of cracking during online quenching.

Therefore, in order to solve this problem existing in the prior art, the present disclosure is intended to develop and provide a novel high-strength petroleum casing pipe and a method for manufacturing the same.

### SUMMARY

One of the objects of the present disclosure is to provide a high-strength petroleum casing pipe. By coordinating the components and designing the process reasonably, the high-strength petroleum casing pipe can acquire excellent mechanical properties. It has both high strength and high toughness, having a yield strength of 552-965 MPa, a tensile strength of ≥689 MPa, an elongation of ≥20%, and a transverse Charpy impact energy at 0° C. of ≥80 J, which can satisfy the required performances of high-strength casing pipes for use in oil and gas fields.

In order to achieve the above object, the present disclosure provides a high-strength petroleum casing pipe, comprising Fe and unavoidable impurity elements, as well as the following chemical elements in mass percentages:
C: 0.06-0.15%;
Si: 0.3-0.5%;
Mn: 1.5-2.2%;
La+Ce: 0.002-0.006%;
Ti≤0.05%;
Al: 0.01-0.03%;
0<N≤0.008%.

Further, in the high-strength petroleum casing pipe described in the present disclosure, the mass percentages of the chemical elements are as follows:
C: 0.06-0.15%;
Si: 0.3-0.5%;
Mn: 1.5-2.2%;
La+Ce: 0.002-0.006%;
Ti≤0.05%;
Al: 0.01-0.03%;
0<N≤0.008%;
a balance of Fe and unavoidable impurities;
preferably, La+Ce: 0.002-0.005%.

In the high-strength petroleum casing pipe described in the present disclosure, the chemical elements are designed according to the following principles:

C: In the high-strength petroleum casing pipe described in the present disclosure, C is a carbide-forming element, which can improve the strength of the steel. When the content of the C element in the steel is lower than 0.06%, the hardenability of the steel will be reduced, thereby reducing the toughness of the steel; however, when the content of the C element in the steel is higher than 0.15%, the segregation of the steel will be worsened significantly, and quenching cracks will easily occur. Therefore, in view of the influence of the C content on the performances of the steel, in order to achieve the high strength required by the petroleum casing pipe, the mass percentage of the C element in the high-strength petroleum casing pipe described in the present disclosure is controlled in the range of 0.06-0.15%.

Of course, in some preferred embodiments, in order to achieve better implementation effect, the mass percentage of the C element may be preferably controlled in the range of 0.08-0.14%.

Si: In the high-strength petroleum casing pipe described in the present disclosure, the Si element can be dissolved in ferrite, and it can improve the yield strength of the steel. In addition, Si is also a ferrite-forming element, which is conducive to improving the toughness of the steel. It should be noted that the content of the Si element in the steel should not be too low. When the content of the Si element is lower than 0.3%, the petroleum casing pipe will be prone to oxidation. At the same time, the amount of the Si element added to the steel should not be too high. Too high a content of the Si element will deteriorate the processing performance and toughness of the steel. Therefore, in order to bring into play the beneficial effects of the Si element, the content of the Si element in the steel must be controlled strictly. In the high-strength petroleum casing pipe described in the present disclosure, the mass percentage of the Si element is controlled in the range of 0.3-0.5%.

Of course, in some preferred embodiments, in order to achieve better implementation effect, the mass percentage of the Si element may be preferably controlled in the range of 0.3-0.45%.

Mn: In the high-strength petroleum casing pipe described in the present disclosure, Mn is an austenite-forming element, and it can improve the hardenability of the steel. In the steel system designed according to the present disclosure, when the content of the Mn element is less than 1.5%, the hardenability of the steel will be reduced significantly, thereby reducing the proportion of martensite in the steel and reducing the toughness of the steel; and when the Mn content in the steel is greater than 2.2%, component segregation is likely to occur, resulting in quenching cracks. Therefore, in view of the influence of the content of the Mn element on the performances of the steel, in the high-strength petroleum casing pipe described in the present disclosure, the mass percentage of the Mn element is controlled in the range of 1.5-2.2%.

Of course, in some preferred embodiments, in order to achieve better implementation effect, the mass percentage of the Mn element may be preferably controlled in the range of 1.6-2.0%.

Rare earth (La, Ce): In the high-strength petroleum casing pipe described in the present disclosure, Ce and La are both rare earth elements. The addition of a rare earth mixture to the steel in a certain proportion can modify and refine the inclusions in the steel. The rare earth modified product formed is REAlO₃, which can remove larger inclusions, reduce the oxygen content, and improve the toughness of the steel. At the same time, the refined inclusions, as nucleation points for dynamic recrystallization during rolling, can also promote the occurrence of recrystallization, thereby refining the austenite grains and inhibiting cracking caused by direct quenching after rolling. The inventors have discovered by research that when the Ce+La content in the steel is >0.006%, coarse inclusions can be formed easily, reducing the toughness of the material; if the Ce+La content in the steel is <0.002%, the effects of grain refinement and inclusion modification are not significant, and quenching cracking is likely to occur. Therefore, in order to bring into play the beneficial effects of the rare earth elements La and Ce, in the high-strength petroleum casing pipe described in the present disclosure, the sum of the contents of the La and Ce elements “rare earth (La, Ce)” is controlled in the range of 0.002-0.006%.

Of course, in some preferred embodiments, in order to achieve better implementation effect, the content of the rare earth elements La and Ce may be preferably controlled in the range of 0.0025-0.004%.

Ti: In the high-strength petroleum casing pipe described in the present disclosure, Ti is a strong carbonitride-forming element. It can refine the austenite grains in the steel significantly and compensate for the strength reduction caused by the reduction of the carbon content. When the content of the Ti content in the steel is greater than 0.05%, coarse TiN will be formed easily, which will reduce the toughness of the material. Therefore, in the high-strength petroleum casing pipe described in the present disclosure, the mass percentage of the Ti element needs to be controlled to be Ti≤0.05%.

Of course, in some preferred embodiments, in order to achieve better implementation effect, the mass percentage of the Ti element may be preferably controlled to be Ti≤0.03%.

Al: In the high-strength petroleum casing pipe described in the present disclosure, Al is a good element for deoxidization and nitrogen fixation, and it can refine the grains effectively. Therefore, in order to bring into play the beneficial effects of the Al element, in the present disclosure, the mass percentage of the Al element is controlled in the range of 0.01-0.03%.

Of course, in some preferred embodiments, in order to achieve better implementation effectiveness, the mass percentage of the Al element may be preferably controlled in the range of 0.01-0.025%.

N: In the high-strength petroleum casing pipe described in the present disclosure, N can combine with Ti to form TiN, and refine austenite grains, thereby inhibiting cracking caused by direct quenching after rolling. Therefore, in the present disclosure, the mass percentage of the N element is controlled to satisfy 0<N≤0.008%.

Further, in the high-strength petroleum casing pipe described in the present disclosure, among the unavoidable impurities, P≤0.015%, S≤0.008%.

Further, in the high-strength petroleum casing pipe described in the present disclosure, among the unavoidable impurities, P<0.013%, S≤0.0025%.

In the high-strength petroleum casing pipe described in the present disclosure, the P and S elements are both impurity elements in the steel pipe. When technical conditions permit, in order to obtain a pipe with better properties and higher quality, the contents of the impurity elements in the high-strength petroleum casing pipe should be minimized.

Therefore, in the present disclosure, the contents of the P and S elements in the steel must be strictly controlled to be P≤0.015% and S≤0.008%. Of course, in some preferred embodiments, in order to achieve better implementation effectiveness, the contents of the P and S elements may be further controlled to satisfy: P≤0.013%, S≤0.0025%.

Further, in the high-strength petroleum casing pipe described in the present disclosure, the mass percentages of the chemical elements further satisfy at least one of the following:
C: 0.08-0.14%;
Si: 0.3-0.45%;
Mn: 1.6-2.0%;
La+Ce: 0.0025-0.004%;
Ti≤0.03%;
Al: 0.01-0.025%.

Further, in the high-strength petroleum casing pipe described in the present disclosure, its microstructure is tempered sorbite.

Further, in the high-strength petroleum casing pipe described in the present disclosure, the grain size grade of its structure is greater than grade 8.5.

Further, in the high-strength petroleum casing pipe described in the present disclosure, its yield strength is ≥552 MPa, its tensile strength is ≥689 MPa, its elongation is ≥20%, and its transverse Charpy impact energy at 0° C. is ≥80 J.

Further, in the high-strength petroleum casing pipe described in the present disclosure, its yield strength is ≥630 MPa, its tensile strength is ≥720 MPa, its elongation is ≥20%, and its transverse Charpy impact energy at 0° C. is ≥80 J.

Further, in the high-strength petroleum casing pipe described in the present disclosure, its yield strength is 552-965 MPa, its tensile strength is ≥689 MPa, its elongation is ≥20%, and its transverse Charpy impact energy at 0° C. is ≥80 J.

Further, the high-strength petroleum casing pipe described in the present disclosure has a yield strength of 630-965 MPa, a tensile strength of 720-1040 MPa, an elongation of 21-26%, and a transverse Charpy impact energy at 0° C. of 89-150 J.

Accordingly, another object of the present disclosure is to provide a method for manufacturing the above high-strength petroleum casing pipe. The method utilizes the residual heat of the steel pipe after hot rolling for quenching, and realizes production with online quenching+tempering heat treatment. It can be used to prepare the above high-strength petroleum casing pipe of the present disclosure in an effective way while reducing the manufacturing cost. It has good application prospects.

In order to achieve the above object, the present disclosure proposes a method for manufacturing the above high-strength petroleum casing pipe, comprising steps of:
(1) Smelting and casting;
(2) Piercing;
(3) Rolling;
(4) Sizing;
(5) Online quenching: Controlling the temperature of the casing pipe body before cooling to be no less than 780° C.; cooling the outer surface of the casing pipe with water at a cooling rate of 40-100° C./S; and controlling the final temperature of cooling to be no higher than 100° C.;
(6) Tempering: Controlling the tempering temperature to be 500-620° C. and the holding time to be 40-70 minutes;
(7) Hot straightening.

In the prior art, a conventional high-strength casing pipe is usually prepared by a process of offline quenching+tempering heat treatment. This method requires room temperature cooling after hot rolling, and then quenching heat treatment is performed by reheating in a quenching heating furnace. This treatment process for a seamless steel pipe not only wastes the residual heat of the steel pipe after rolling, but also involves an extra heat treatment step, leading to increased cost and large consumption of resources and energy, which brings many restrictions to the development and efficient production of high-quality pipes.

Different from the prior art, in the method for manufacturing the high-strength petroleum casing pipe as described in the present disclosure, the inventors have proposed utilizing the residual heat of the steel pipe after hot rolling for quenching, so as to eliminate the offline quenching step and realize production with online quenching+tempering heat treatment, thereby significantly improving production efficiency, reducing production cost, reducing energy consumption and realizing green manufacturing.

However, it should be noted that if the casing pipe is directly quenched after hot rolling, it will store relatively high energy due to grain distortion, and it is easy to crack during the quenching process; at the same time, due to the high rolling temperature of the casing pipe, the grain size of the casing pipe after rolling is relatively large, generally at grade 5-7, so that quenching cracking occurs easily. Therefore, the process adopted by the present disclosure requires an optimized design of the type and content of the alloying elements to prevent cracking and stress concentration in the pipe body, and guarantee production safety and stable quality. To this end, when designing the chemical composition, the inventors add rare earth elements La and Ce to the steel to modify and refine the inclusions in the steel, remove large inclusions, reduce the oxygen content, and improve the toughness. At the same time, the refined inclusions, as nucleation particles for dynamic recrystallization during rolling, promote occurrence of recrystallization, thereby refining the austenite grains and providing a structure having a grain size of not less than grade 8.5, so that cracking caused by direct quenching after rolling can be inhibited.

In addition, a small amount of the Ti element may be added to the high-strength petroleum casing pipe designed according to the present disclosure, and the TiN compound formed can be used to refine the austenite grains and inhibit cracking caused by direct quenching after rolling.

Further, in the manufacturing method described in the present disclosure, in the smelting step of step (1), the rare earth alloying elements are added in the VD (Vacuum Degassing) or LF (Ladle Furnace Refining) process, and in the casting step, the superheat of the molten steel is controlled to be less than or equal to 40° C., and the continuous casting speed is 1.6-2.4 m/min, preferably 1.8-2.4 m/min. Preferably, the superheat of the molten steel is in the range of 15-40° C.

Further, in the manufacturing method described in the present disclosure, in step (2), a round blank is soaked in a furnace at 1200-1290° C., and the piercing temperature is 1120-1240° C.

Further, in the manufacturing method described in the present disclosure, in step (3), the final rolling temperature is controlled to be 920-1000° C.

Further, in the manufacturing method described in the present disclosure, in step (4), the sizing temperature is controlled to be 840-910° C. Preferably, after step (4) is completed, step (5) is performed directly using the residual heat of the pipe body before cooling.

Further, in the manufacturing method described in the present disclosure, in step (7), the hot straightening temperature is controlled to be 400-520° C.

Further, in step (5), the temperature of the casing pipe body before cooling is controlled to be 780° C.-910° C., and the final temperature of cooling is controlled to be 30-90° C.

Further, in step (6), the tempering temperature is controlled to be 520° C.-600° C.

Compared with the prior art, the high-strength petroleum casing pipe and the manufacturing method thereof described in the present disclosure have the following advantages and beneficial effects:

In the present disclosure, the inventors have proposed utilizing the residual heat of the steel pipe after hot rolling for quenching, so as to eliminate the offline quenching step and realize production with online quenching+tempering heat treatment, thereby significantly improving production efficiency, reducing production cost, reducing energy consumption and realizing green manufacturing.

In the method for manufacturing the high-strength petroleum casing pipe described in the present disclosure, the TMCP technology is utilized to enable the steel to obtain higher strength and better toughness. The process operation is simple, and large-scale production and manufacturing can be realized easily. Therefore, good economic benefits can be achieved. The finished high-strength petroleum casing pipe of 80-110 ksi steel grade prepared by this manufacturing process exhibits excellent mechanical performances. It has a yield strength of 552-965 MPa, a tensile strength of ≥689 MPa, an elongation of ≥20%, and a transverse Charpy impact energy at 0° C. of ≥80 J, which can meet the requirements of oil and gas fields for the performances of a high-strength casing pipe in use. It has good application prospects.

### DESCRIPTION OF THE DRAWINGS

FIG. 1 is a photograph showing the metallographic structure of the high-strength petroleum casing pipe of Example 4.

FIG. 2 is a photograph showing the metallographic structure of the comparative steel pipe of Comparative Example 5.

### DETAILED DESCRIPTION

The high-strength petroleum casing pipe of the present disclosure and the manufacturing method thereof will be further explained and illustrated below with reference to the accompanying drawings of the specification and the specific Examples. However, such explanation and illustration do not constitute an improper limitation on the technical solution of the present disclosure.

### Examples 1-6 and Comparative Examples 1-7

The high-strength petroleum casing pipes of Examples 1-6 of the present disclosure and the comparative steel pipes of Comparative Examples 1-7 were all prepared by the following steps:
(1) Smelting and casting according to the mass percentages of the chemical elements shown in Table 1: During the smelting process, the mass percentages of the chemical elements in the high-strength petroleum casing pipes of Examples 1-6 and the comparative steel pipes of Comparative Examples 1-7 were controlled as shown in Table 1, and the rare earth alloying elements were added in the VD or LF process. After the smelting was completed, continuous casting was performed to form a pipe blank, and the superheat of the molten steel was controlled to be lower than 40° C. The continuous casting speed was 1.8-2.4 m/min.
(2) Piercing: The round blank obtained by continuous casting was soaked in an annular furnace at 1200-1290° C., and the piercing temperature was controlled to be 1120-1240° C.
(3) Rolling: The final rolling temperature was controlled to be 920-1000° C.
(4) Sizing: The sizing temperature was controlled to be 840-910° C.
(5) Online quenching: The temperature of the casing pipe body before cooling was controlled to be no less than 780° C. The outer surface of the casing pipe was cooled with water at a cooling rate of 40-100° C./S. The final temperature of cooling was controlled to be no higher than 100° C.
(6) Tempering: The tempering temperature was controlled to be 500-620° C., and the holding time was 40-70 minutes.
(7) Hot straightening: The hot straightening temperature was controlled to be 400-520° C.

It should be noted that the designs of the chemical element compositions and related processes of the high-strength petroleum casing pipes of Examples 1-6 described in the present disclosure all meet the design specification requirements of the present disclosure. Although the comparative steel pipes of Comparative Examples 1-7 were also produced by the above process steps, their chemical element compositions and/or related process parameters do not conform to the parameters designed according to the present disclosure.

Table 1 lists the mass percentages of the chemical elements in the high-strength petroleum casing pipes of Examples 1-6 and the comparative steel pipes of Comparative Examples 1-7.

TABLE 1
(the balance is Fe and other unavoidable impurities besides P and S)

| | Chemical elements | | | | | | | | |
|---|---|---|---|---|---|---|---|---|---|
| | C | Si | Mn | S | P | Ti | La + Ce | Al | N |
| No. | (wt %) | (wt %) | (wt %) | (wt %) | (wt %) | (wt %) | (wt %) | (wt %) | (wt %) |
| Ex. 1 | 0.06 | 0.3 | 1.6 | 0.002 | 0.01 | 0.02 | 0.002 | 0.01 | 0.004 |
| Ex. 2 | 0.08 | 0.4 | 1.8 | 0.003 | 0.011 | 0.025 | 0.0025 | 0.02 | 0.005 |
| Ex. 3 | 0.1 | 0.5 | 1.5 | 0.001 | 0.012 | 0 | 0.005 | 0.025 | 0.006 |
| Ex. 4 | 0.12 | 0.4 | 2.2 | 0.003 | 0.015 | 0.03 | 0.004 | 0.03 | 0.007 |
| Ex. 5 | 0.15 | 0.5 | 2 | 0.002 | 0.012 | 0.05 | 0.003 | 0.02 | 0.008 |
| Ex. 6 | 0.11 | 0.4 | 1.9 | 0.002 | 0.013 | 0.01 | 0.0035 | 0.015 | 0.003 |
| Comp. Ex. 1 | 0.03 | 0.3 | 1.6 | 0.002 | 0.01 | 0.02 | 0.002 | 0.01 | 0.004 |
| Comp. Ex. 2 | 0.2 | 0.3 | 1.6 | 0.003 | 0.011 | 0.02 | 0.002 | 0.01 | 0.004 |
| Comp. Ex. 3 | 0.15 | 0.5 | 1.0 | 0.001 | 0.012 | 0.05 | 0.003 | 0.02 | 0.008 |
| Comp. Ex. 4 | 0.15 | 0.5 | 2.8 | 0.003 | 0.015 | 0.05 | 0.003 | 0.02 | 0.008 |
| Comp. Ex. 5 | 0.12 | 0.4 | 2.2 | 0.002 | 0.017 | 0.03 | 0.001 | 0.03 | 0.007 |
| Comp. Ex. 6 | 0.12 | 0.4 | 2.2 | 0.002 | 0.013 | 0.03 | 0.007 | 0.03 | 0.007 |
| Comp. Ex. 7 | 0.12 | 0.4 | 2.2 | 0.002 | 0.014 | 0.03 | 0.004 | 0.03 | 0.007 |

Note:
The contents of La and Ce are not listed separately in Table 1 above, because rare earths exist as mixtures and the individual contents of La and Ce cannot be determined precisely.

Table 2-1 and Table 2-2 list the specific process parameters used in the above process steps for manufacturing the high-strength petroleum casing pipe of Examples 1-6 and the comparative steel pipes of Comparative Examples 1-7.

TABLE 2-1

| | Step (1) | | Step (2) | | Step (3) | Step (4) |
|---|---|---|---|---|---|---|
| | Molten steel | Continuous | Furnace | Piecing | Finish rolling | Hot sizing |
| | superheat | casting speed | temperature | temperature | temperature | temperature |
| No. | (° C.) | (m/min) | (° C.) | (° C.) | (° C.) | (° C.) |
| Ex. 1 | 15 | 2 | 1200 | 1120 | 920 | 840 |
| Ex. 2 | 20 | 1.8 | 1270 | 1160 | 960 | 850 |
| Ex. 3 | 30 | 1.6 | 1240 | 1210 | 930 | 870 |
| Ex. 4 | 25 | 2.4 | 1290 | 1190 | 980 | 910 |
| Ex. 5 | 40 | 1.8 | 1260 | 1240 | 1000 | 890 |
| Ex. 6 | 30 | 1.6 | 1240 | 1210 | 930 | 870 |
| Comp. Ex. 1 | 15 | 2 | 1200 | 1120 | 900 | 830 |
| Comp. Ex. 2 | 15 | 2 | 1200 | 1120 | 900 | 830 |
| Comp. Ex. 3 | 20 | 1.8 | 1270 | 1160 | 910 | 850 |
| Comp. Ex. 4 | 20 | 1.8 | 1270 | 1160 | 910 | 850 |
| Comp. Ex. 5 | 30 | 1.6 | 1240 | 1210 | 930 | 870 |
| Comp. Ex. 6 | 30 | 1.6 | 1240 | 1210 | 930 | 870 |
| Comp. Ex. 7 | 30 | 1.6 | 1240 | 1210 | 930 | 870 |

TABLE 2-2

| | Step (5) | | | | | |
|---|---|---|---|---|---|---|
| | Casing | | | | | Step (7) |
| | pipe body | | Final | Step (6) | | Hot |
| | temperature | | temperature | Tempering | Tempering | straightening |
| | before cooling | Water cooling | of cooling | temperature | holding time | temperature |
| No. | (° C.) | rate (° C./S) | (° C.) | (° C.) | (min) | (° C.) |
| Ex. 1 | 910 | 40 | 90 | 580 | 40 | 400 |
| Ex. 2 | 890 | 60 | 80 | 550 | 60 | 420 |
| Ex. 3 | 870 | 70 | 70 | 590 | 60 | 440 |
| Ex. 4 | 780 | 80 | 50 | 520 | 50 | 480 |
| Ex. 5 | 840 | 100 | 30 | 600 | 70 | 500 |
| Ex. 6 | 850 | 60 | 40 | 580 | 55 | 520 |
| Comp. Ex. 1 | 910 | 40 | 90 | 580 | 40 | 400 |
| Comp. Ex. 2 | 910 | 40 | 80 | 580 | 40 | 420 |
| Comp. Ex. 3 | 890 | 60 | 70 | 550 | 60 | 440 |
| Comp. Ex. 4 | 890 | 60 | 50 | 550 | 60 | 480 |
| Comp. Ex. 5 | 870 | 70 | 30 | 500 | 60 | 500 |
| Comp. Ex. 6 | 870 | 70 | 40 | 500 | 60 | 520 |
| Comp. Ex. 7 | 870 | — | 90 | 500 | 60 | 490 |

Among the above Examples and Comparative Examples, a controlled cooling process was not used in Comparative Example 7; instead, an offline heat treatment process, namely, tempering and holding at 500° C. for 60 minutes, was used.

The finished high-strength petroleum casing pipes of Examples 1-6 and comparative steel pipes of Comparative Examples 1-7 prepared above were sampled respectively, and various performance tests were performed on the steel pipes of the Examples and Comparative Examples. The test results are listed in Table 3.

The methods for testing the relevant properties are as follows:
(1) Tensile test: The test was conducted according to ASTM A370 standard to obtain the yield strength, tensile strength and elongation values of the steel pipes of the Examples and Comparative Examples at room temperature.
(2) Impact test: The steel pipes of the Examples and Comparative Examples were tested according to ASTM E23 standard to obtain the transverse impact toughness at 0° C.

Table 3 lists the performance test results of the high-strength petroleum casing pipes of Examples 1-6 and the comparative steel pipes of Comparative Examples 1-7.

TABLE 3

| | Yield | Tensile | | Transverse |
|---|---|---|---|---|
| | strength | strength | Elongation | impact energy, |
| No. | (MPa) | (MPa) | (%) | 0° C. (J) |
| Ex. 1 | 630 | 720 | 26 | 150 |
| Ex. 2 | 700 | 790 | 24 | 122 |
| Ex. 3 | 660 | 760 | 25 | 134 |
| Ex. 4 | 965 | 1040 | 21 | 92 |
| Ex. 5 | 850 | 940 | 23 | 89 |
| Ex. 6 | 830 | 910 | 22 | 105 |
| Comp. Ex. 1 | 470 | 550 | 33 | 180 |
| Comp. Ex. 2 | 750 | 840 | 22 | 55 |
| Comp. Ex. 3 | 530 | 610 | 26 | 95 |
| Comp. Ex. 4 | 980 | 1060 | 18 | 35 |
| Comp. Ex. 5 | 870 | 920 | 22 | 40 |
| Comp. Ex. 6 | 940 | 990 | 19 | 38 |
| Comp. Ex. 7 | 540 | 630 | 25 | 85 |

As it can be seen from Table 3, compared with the comparative steel pipes of Comparative Examples 1-7, the overall performances of the high-strength petroleum casing pipes of Examples 1-6 according to the present disclosure were significantly better.

Referring to Table 3, it can be seen that the high-strength petroleum casing pipes of Examples 1-6 obtained according to the present disclosure all had excellent mechanical performances, with a yield strength in the range of 630-965 MPa, a tensile strength in the range of 720-1040 MPa, an elongation in the range of 21-26%, and a transverse Charpy impact energy at 0° C. in the range of 89-150 J. That is, the casing pipes in Examples 1-6 all had high strength and high toughness.

In contrast, in the design of the chemical compositions of Comparative Examples 1 and 2, the content of the C element exceeded the range defined by the technical solution of the present disclosure. The content of the Mn element in Comparative Examples 3 and 4 exceeded the range defined by the technical solution of the present disclosure. The content of the rare earth elements (La, Ce) in Comparative Examples 5 and 6 exceeded the range defined by the technical solution of the present disclosure. A controlled cooling process was not used in Comparative Example 7; instead, an offline heat treatment process (holding at 900° C. for 40 min; water quenching; tempering at 550° C. and holding for 60 minutes) was used.

As a result of such designs, at least one mechanical performance of the comparative steel pipes prepared according to Comparative Examples 1-6 didn't meet the requirements of high strength and high toughness proposed by this disclosure.

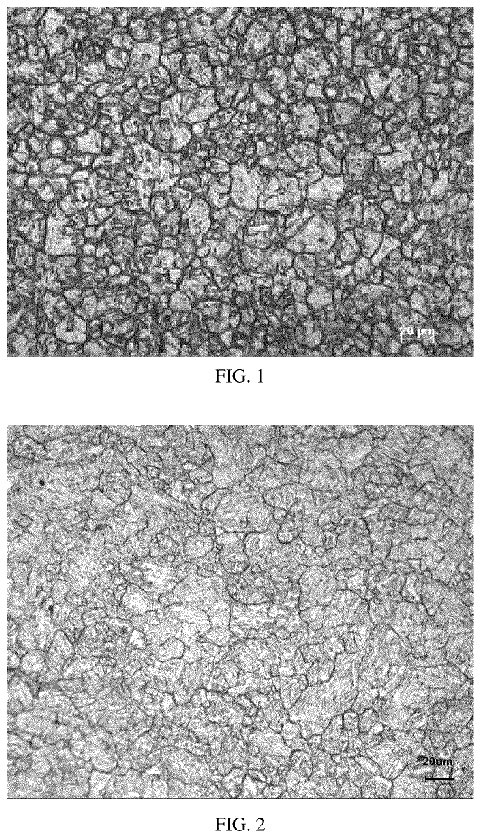

FIG. 1 is a photograph showing the metallographic structure of the high-strength petroleum casing pipe of Example 4.

As shown by FIG. 1, in Example 4, the microstructure of the high-strength petroleum casing pipe prepared therein was tempered sorbite, and the grain size thereof was grade 8.5. It can be seen that the addition of rare earth elements La and Ce can refine the grains effectively and improve the toughness of the material.

FIG. 2 is a photograph showing the metallographic structure of the comparative steel pipe of Comparative Example 5.

As shown by FIG. 2, in the comparative steel pipe prepared according to Comparative Example 5, the grain size was grade 7; the rare earth content was less than the lower limit value set by the present disclosure; there was no obvious grain refinement effect; and the material toughness was reduced.

The above grain size grades were determined in accordance with GB/T 6394-2017 standard.

It should be noted that combinations of the various technical features in this case are not limited to the combinations described in the claims of this case or the combinations described in the specific Examples. All technical features recorded in this case can be combined freely or associated in any way unless a contradiction occurs.

It should also be noted that the Examples listed above are only specific embodiments of the present disclosure. Obviously, the present disclosure is not limited to the above Examples, and changes or modifications made thereto can be directly derived from the present disclosure or easily conceived of by those skilled in the art, all of which fall within the protection scope of the present disclosure.

1. A high-strength petroleum casing pipe, comprising Fe and unavoidable impurity elements, wherein it further comprises the following chemical elements in mass percentages:
C: 0.06-0.15%;
Si: 0.3-0.5%;
Mn: 1.5-2.2%;
La+Ce: 0.002-0.006%;
Ti≤0.05%;
Al: 0.01-0.03%;
0<N≤0.008%.

2. The high-strength petroleum casing pipe of claim 1, wherein the mass percentages of the chemical elements are as follows:
C: 0.06-0.15%;
Si: 0.3-0.5%;
Mn: 1.5-2.2%;
La+Ce: 0.002-0.006%;
Ti≤0.05%;
Al: 0.01-0.03%;
0<N≤0.008%;
a balance of Fe and unavoidable impurities.

3. The high-strength petroleum casing pipe of claim 1, wherein among the unavoidable impurity elements, P≤0.015%, S≤0.008%.

4. The high-strength petroleum casing pipe of claim 3, wherein among the unavoidable impurities, P<0.013%, S≤0.0025%.

5. The high-strength petroleum casing pipe of claim 1, wherein the mass percentages of the chemical elements further satisfy at least one of the following:
C: 0.08-0.14%;
Si: 0.3-0.45%;
Mn: 1.6-2.0%;
La+Ce: 0.0025-0.004%;
Ti≤0.03%;
Al: 0.01-0.025%.

6. The high-strength petroleum casing pipe of claim 1, wherein its microstructure is tempered sorbite.

7. The high-strength petroleum casing pipe of claim 6, wherein its grain size grade is greater than or equal to grade 8.5.

8. The high-strength petroleum casing pipe of claim 1, wherein it the high-strength petroleum casting pipe has a yield strength of ≥552 MPa, a tensile strength of ≥689 MPa, an elongation of ≥20%, and a transverse Charpy impact energy at 0° C. of ≥80 J.

9. A method for manufacturing the high-strength petroleum casing pipe of claim 1, comprising steps of:
(1) Smelting and casting;
(2) Piercing;
(3) Rolling;
(4) Sizing;
(5) Online quenching: Controlling a temperature of a casing pipe body before cooling to be no less than 780° C.; cooling an outer surface of the casing pipe with water at a cooling rate of 40-100° C./S; and controlling a final temperature of cooling to be no higher than 100° C.;
(6) Tempering: Controlling a tempering temperature to be 500-620° C. and a holding time to be 40-70 minutes;
(7) Hot straightening.

10. The method of claim 9, wherein in a smelting step of step (1), rare earth alloying elements are added in a VD or LF process; and in a casting step, a superheat of molten steel is controlled to be less than 40° C., and a continuous casting speed is 1.6-2.4 m/min.

11. The method of claim 9, wherein in step (2), a round blank is soaked in a furnace at 1200-1290° C., and a piercing temperature is 1120-1240° C.

12. The method of claim 9, wherein in step (3), a finial rolling temperature is controlled to be 920-1000° C.

13. The method of claim 9, wherein in step (4), a sizing temperature is controlled to be 840-910° C.

14. The method of claim 9, wherein in step (7), a hot straightening temperature is controlled to be 400-520° C.

15. The method of claim 9, wherein in step (5), the temperature of the casing pipe body before cooling is controlled to be 780° C.-910° C., and the final temperature of cooling is controlled to be 30-90° C.; in step (6), the tempering temperature is controlled to be 520° C.-600° C.

16. The high-strength petroleum casing pipe of claim 1, wherein the content of La+Ce is 0.002-0.005%.

17. The high-strength petroleum casing pipe of claim 8, wherein the high-strength petroleum casing pipe has a yield strength of 630-965 MPa, a tensile strength of 720-1040 MPa, an elongation of 21-26%, and a transverse Charpy impact energy at 0° C. of 89-150 J.

18. The high-strength petroleum casing pipe of claim 2, wherein the mass percentages of the chemical elements further satisfy at least one of the following:
C: 0.08-0.14%;
Si: 0.3-0.45%;
Mn: 1.6-2.0%;
La+Ce: 0.0025-0.004%;
Ti≤0.03%;
Al: 0.01-0.025%.

19. The high-strength petroleum casing pipe of claim 2, wherein:
its microstructure is tempered sorbite; and/or
the high-strength petroleum casing pipe has a yield strength of ≥552 MPa, a tensile strength of ≥689 MPa, an elongation of ≥20%, and a transverse Charpy impact energy at 0° C. of ≥80 J.

20. The method of claim 9, wherein:
in a smelting step of step (1), the superheat of molten steel is 15-40° C.; and/or
after step (4) is completed, step (5) is performed directly using residual heat of the pipe body before cooling.
